(19) United States
(12) Patent Application Publication
(10) Pub. No.: US 2004/0205930 A1
(43) Pub. Date: Oct. 21, 2004

(54) Door closer

(76) Inventor: Tan-Cheng Huang, Taichung (TW)

Correspondence Address: CHARLES E. BAXLEY, ESQUIRE, Fifth Floor, 59 John Street, New York, NY, 10038, US

(21) Appl. No.: 10/417,781

(22) Filed: Apr. 17, 2003

(51) Int. Cl. E05F 3/00

(52) U.S. Cl. 16/64

(57) ABSTRACT

A door closer includes a door shaft, a housing, a sliding member, a door-closing spring, a sliding board, a pair of sliding blocks, a cone member and a door-opening spring. The door shaft is utilized to drive a sliding member in a housing of the door closer. Between an end of the sliding member and the housing a door-closing spring is tensioned, and another end of the sliding member is engaged with a cone member and a sliding board respectively in turn, the cone member serves for cooperating with the a pair of sliding blocks in the sliding board each of which provided with an incline at an end and a spring respectively. The sliding blocks further have retainer portions corresponding to the housing of the door closer, between the sliding board and the housing a door-opening spring is disposed, the retainer portions can be locked and fastened to a side of the housing.

### BACKGROUND OF THE INVENTION

1. Field of the Invention

The present invention relates to a door closer, and more particularly to an auxiliary structure applied to vary kinds of doors and/or windows, which is specially a door closer driven by virtue of the door shaft; the door closer is interiorly provided with a sliding member, a door-closing spring, a door-opening spring, a cone member, a sliding board and blocks such that not only provide effective assistant door-opening/closing force but also substitute the low-cost spring device for the expensive hydraulic system.

2. Description of the Prior Arts

The conventional door closers sold in market normally utilize hydraulic or pneumatic system as a buffer to exerted force. The hydraulic (pneumatic) door closer is disposed between the door and a wall to provide buffering effect at the end of a door opening or closing action. This kind of hydraulic (pneumatic) door closer has been commonly applied to all kinds of doors and windows, however, there are still some disadvantages will be resulted from real operation as follows:

First, due to the conventional hydraulic (pneumatic) door closer is not provided with motor power, the buffering and door-closing effect are resulted from the reverse pressure and flow of the air or liquid after a compression, in this case, this kind of conventional door closer is only able to provide door-closing effect and the terminal buffering effect.

Second, the conventional hydraulic (pneumatic) door closer is very expensive, the pipeline, leak-resistant member, liquid oil of which are all high-cost. Moreover, the pipeline of which must be thickened and no gas hole are accepted, and sealing member required being disposed between the pipelines as well as between the piston and cylinder. Thereby the price of the hydraulic system is very high.

The present invention has arisen to mitigate and/or obviate the afore-described disadvantages of the conventional door closer.

### SUMMARY OF THE INVENTION

In accordance with one respect of the present invention, there is provided a door closer, in which, a door shaft is utilized to drive a sliding member in a housing of the door closer, between an end of the sliding member and the housing a door-closing spring is tensioned, and another end of the sliding member is engaged with a cone member and a sliding board respectively in turn, the cone member serves for cooperating with the pair of sliding blocks in the sliding board each of which provided with an incline at an end and a spring respectively. The sliding blocks further having retainer portions corresponding to the housing of the door closer, between the sliding board and the housing a door-opening spring is disposed, the retainer portions can be locked and fastened to a side of the housing, in addition, the cone member may be driven by the sliding member so as to unlock and release the retainer portions from the inner side.

The primary objective of the present invention is to provide a door closer having an ability of providing an effective end buffering effect, assistant door-opening force and door-closing force.

Another objective of the present invention is to provide a door closer that is cheap and utilize the low-cost spring members to substitute for the expensive hydraulic (pneumatic) system.

The further object of the present invention is to provide a door closer, the buffering distance and assistant force of which can be adjusted without difficulties.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is an exploded view of a door closer in accordance with a first embodiment of the present invention;

FIG. 2 is a partial exploded view of the door closer in accordance with a first embodiment of the present invention;

FIG. 3 is another partial exploded view of the door closer in accordance with a first embodiment of the present invention;

FIG. 4 is a cross sectional view of the door closer in accordance with a first embodiment of the present invention;

FIG. 5 is second cross sectional view of the door closer in accordance with a first embodiment of the present invention;

FIG. 6 is third cross sectional view of the door closer in accordance with a first embodiment of the present invention;

FIG. 7 is fourth cross sectional view of the door closer in accordance with a first embodiment of the present invention;

FIG. 8 is an exploded view of the door closer in accordance with a second embodiment of the present invention;

FIG. 9 is a cross sectional view of the door closer in accordance with a second embodiment of the present invention;

FIG. 10 is cross sectional view of the door closer in accordance with a third embodiment of the present invention;

FIG. 11 is an exploded view of the door closer in accordance with a fourth embodiment of the present invention;

FIG. 12 is a cross sectional view of the door closer in accordance with a fourth embodiment of the present invention;

FIG. 13 is an exploded view of the door closer in accordance with a fifth embodiment of the present invention;

FIG. 14 is a cross sectional view of the door closer in accordance with a fifth embodiment of the present invention;

### DETAILED DESCRIPTION OF THE PREFERRED EMBODIMENTS

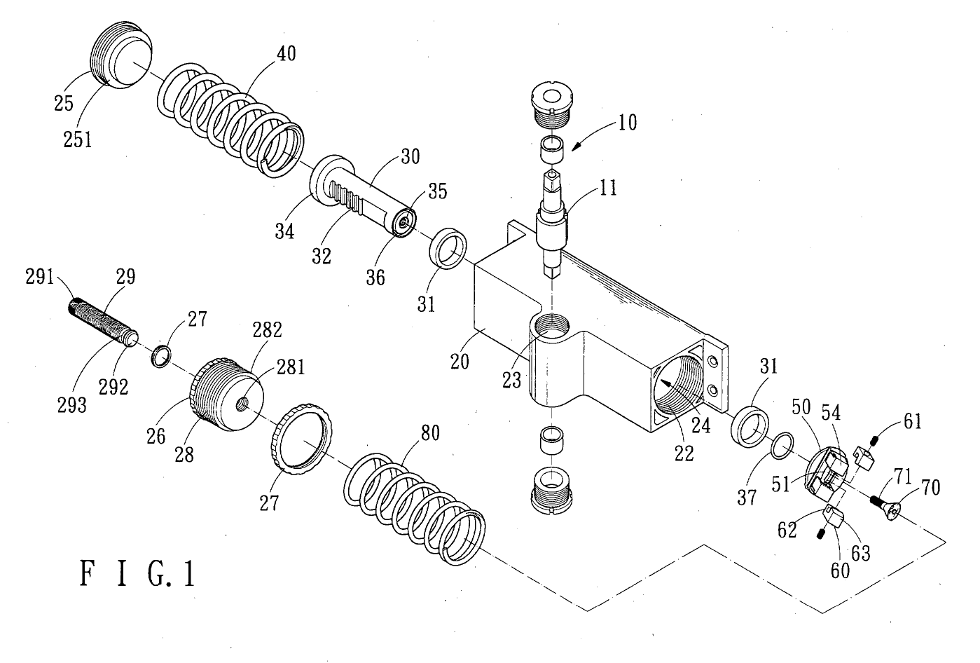

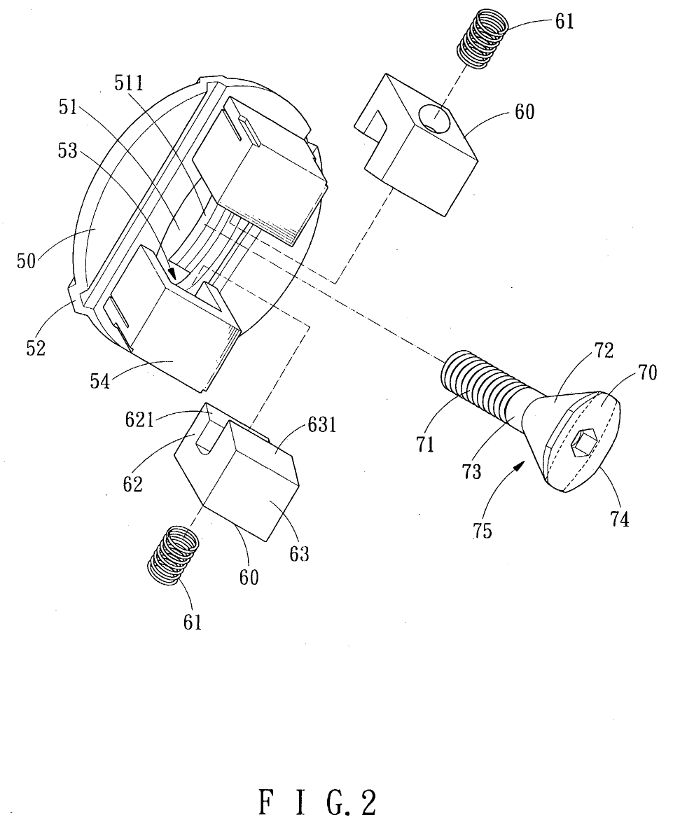

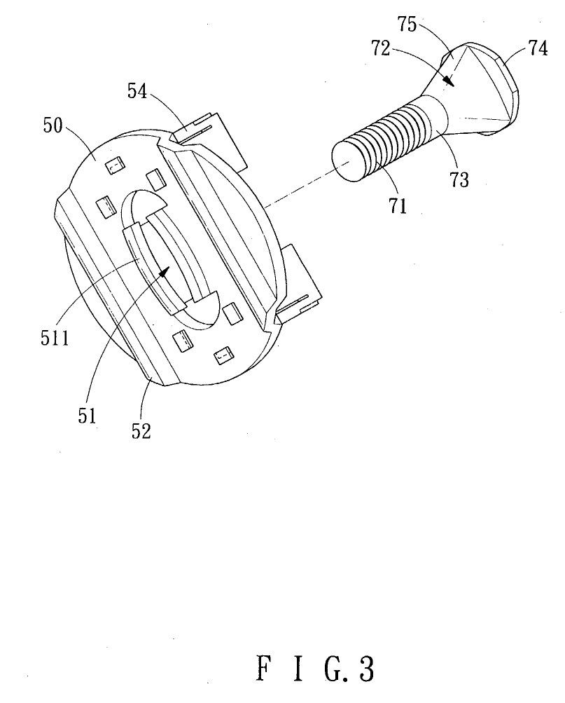

Referring to FIGS. 1-4, wherein a door closer in accordance with a first embodiment of the present invention is shown and generally including a door shaft 10, a housing 20, a sliding member 30, a door-closing spring 40, a sliding board 50, a pair of sliding blocks 60, a cone member 70 and a door-opening spring 80.

The door shaft 10 is provided with a gear 11 and revolves along with the opening and closing action of the door.

The housing 20 has an internal space 24 interiorly defined thereof and at both ends of which are provided with first inner threads 21 and second inner threads 22 respectively. In the middle of the housing 20 a hole 23 is defined for receiving the door shaft 10 therein along with the gear 11 of the door shaft accommodated in the internal space 24 of the housing 20. A spring cover 25 is provided with an annular dent 251 at an end and to be engaged with the first inner threads 21. While the second inner threads 22 cooperates with a screw nut 27 to engage with an adjusting cover 28. The adjusting cover 28 has a plurality of anti-skid knurls 26 formed at an end and an annular dent 282 at the other, in the center of the adjusting cover 28 a threaded hole 281 is defined. An adjustable bolt 29 serves to screw in the threaded hole 281 by virtue of another screw nut 27. About periphery of the end of the adjustable bolt 29 a plurality of anti-skid knurls 291 are defined, and at another end of the same corresponding to the space 24 is provided with a chamfer 292 and contiguous to it an engaging portion 293 is defined.

The sliding member 30 is movably accommodated in the internal space 24 of the housing 20 by virtue of a pair of abrasion-resistant gaskets 31. The sliding member 30 has a flanged first end 34 with an annular dent 33 defined thereof and a second end formed with a threaded hole 35 and an annular groove 36 respectively. The annular dent 33 corresponding to the annular dent 251 of the spring cover 25 in the housing 20, while in the annular groove 36 a cushion ring 37 is received with corresponding to the adjusting cover 28. The sliding member 30 is provided with a plurality of teeth 32 at the outer periphery for engaging with the gear 11 of the door shaft 10.

The door-closing spring 40 serves to provide the force for closing door and tensioned between the spring cover 25 of the housing 20 and the flanged first end 34 of the sliding member 30, with a first end abutting against the annular dent 251 of the spring cover 25 and a second end abutting against the annular dent 33 of the flanged first end 34.

The sliding board 50 received in the internal space 24 of the housing 20 and simultaneously abutting against the cushion ring 37 of the sliding member 30. At a side corresponding to the adjusting cover 28 the sliding board 50 is provided with a pair of pedestals 54 and located opposite to each other. The pedestal 54 each has a recess 53 also oppositely located. The two pedestals 54 define a space therebetween for insertion of the adjustable bolt 29 of the housing 20. Moreover, at the center of the sliding board 50 an elliptical through hole 51 is defined, in the inner surface of the elliptical through hole 51 a stop portion 511 is disposed there in a protruding manner and at the surface of the same corresponding to the spring cover 25 a pair of ribs 52 is defined.

The slide blocks 60 are [symbol] -shaped, each of which together with a spring 61 are received in the corresponding recess 53 of the pedestals 54 of the sliding board 50 respectively, the slide blocks 60 and the springs 61 are confined but movable in the corresponding recesses 53 respectively. The extension of the [symbol] -shaped portion of the each slide blocks 60 is divided into a retainer portion 63 and a contacting portion 62. The contacting portion 62 of each slide blocks 60 has an incline 621 formed at the end, the two inclines 621 are opposite located and each of which is outward inclined from the inner side corresponding to the sliding board 50. While the retainer portions 63 of each slide blocks 60 are corresponding to the annular dents 293 of the adjustable rod 29 respectively. Both slide blocks 60 are provided with a bevel angle 631 at the retainer portions 63 respectively, these two bevel angles 631 are corresponding to each other and each of which is outward inclined from the inner side with respect to the adjustable rod 29 so as to cooperate with the chamfer 292. Moreover, the sliding blocks 60 together with the springs 61 slide in the corresponding recess 53 of the pedestals 54 of the sliding board 50.

The cone member 70 movably received in the internal space 24 of the housing 20, which is provided with a rod 73 at the end corresponding to the sliding member 30 and a conical surface 72 along with a stop plate 74 at the other end. The rod 73 has threads 71 defined at the end; meanwhile, the conical surface 72 is rather elliptical. The cone member 70 is received in the sliding member 30 by virtue of the threads 71 engaging with the threaded hole 35, while the conical surface 72 of the rod 73 is movably inserted in the elliptical through hole 51 at the center of the sliding board 50 and the stop plate 74 of the cone member 70 is confined by the stop portion 511 of the sliding board 50. The conical surface 72 is outward inclined from the inner side where corresponding to the sliding board 50 and serves to abut against the inclines 621 of the each two slide blocks 60.

The door-opening spring 80 serves to provide force for opening the door and tensioned between the adjusting cover 28 of the housing 20 and the sliding board 50 with a first end abutting against the annular dent 282 of the adjusting cover 28 and a second end abutting against the pedestals 54 of the sliding board 50.

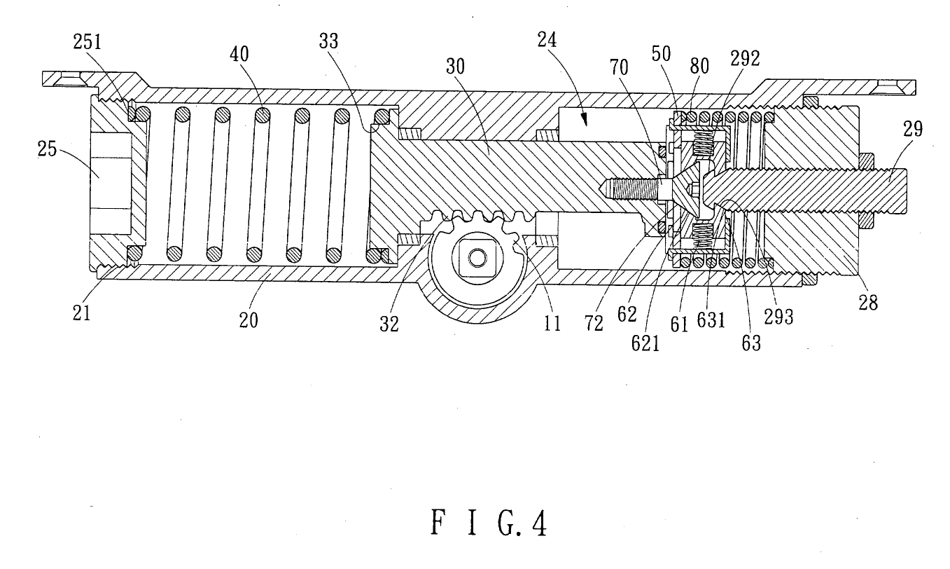

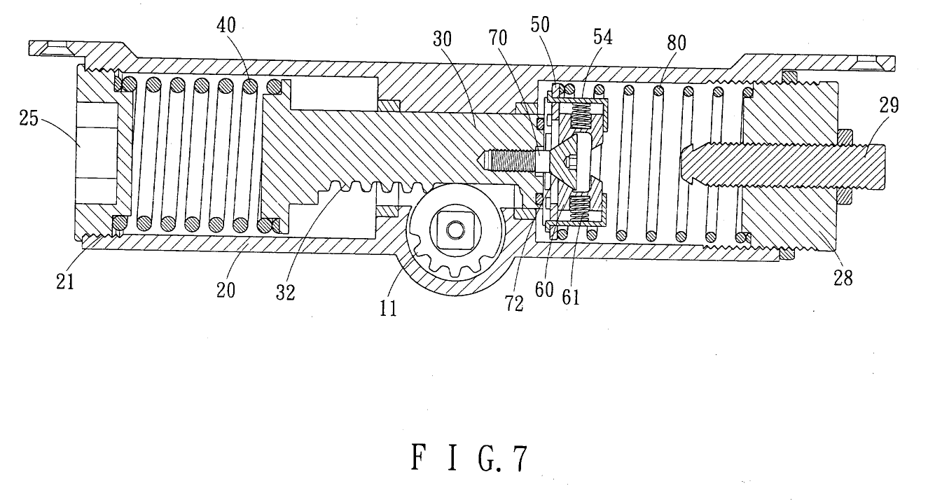

Referring now to FIGS. 4-7, in case of the door is in a closed state (with referring to FIG. 4), the sliding member 30 is pushed toward the end of the adjusting cover 28 by the expansion force of the door-closing spring 40 and so is the sliding board 50. Due to the sliding board 50 abuts against the door-opening spring 80, and the door-opening spring 80 has an end abutting against the sliding board 50 and the other end abutting against the adjusting cover 28, accordingly the door-opening spring 80 is compressed. And then when the sliding member 30 pushes the sliding board 50 toward the adjusting cover 28, the slide blocks 60 in the pedestals 54 of the sliding 50 followed to move toward the adjustable bolt 29 of the adjusting cover 28. While the opposite paired retainer portions 63 of the slide blocks 60 will be engaged in the engaging portion 293 of the adjustable bolt 29. At the same time, the retainer portions 63 of the sliding blocks 60 together with the engaging portion 293 of the adjustable bolt 29 confine the door-opening spring 80 such that the restoring force of it cannot be released. However, the door-closing spring 40 starts to expand and provides a predetermined force to the sliding member 30 so as to cooperate in locking position of the retainer portions 63 of the slide blocks 60. By such a manner, in case of a state of door closed, the door closer of the present invention will maintain a predetermined force of door-closing such that the door will not be opened by itself or by a breeze.

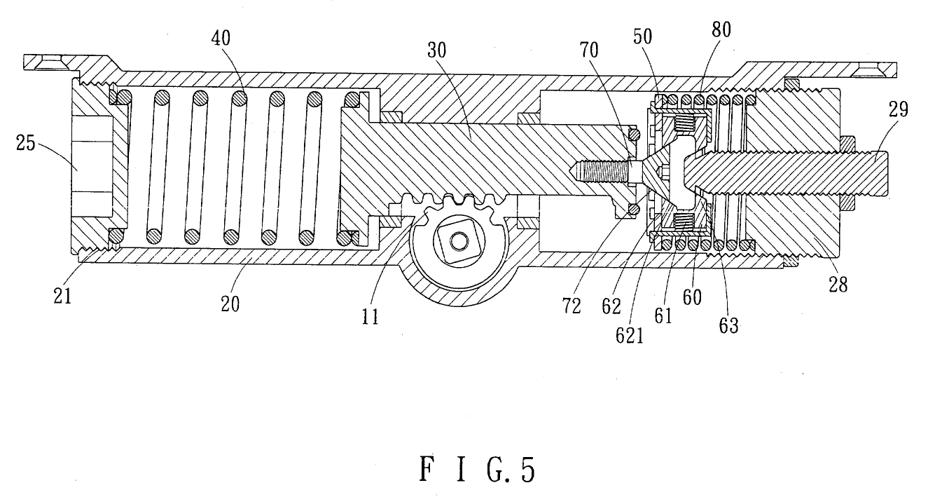

In case that the door being pushed by an user (with referring to FIG. 5), the gear 11 of the door shaft 10 will cooperate with the teeth 32 to push the sliding member 30 toward the end of the spring cover 25. And then the abutting member 70 is driven to move toward the spring cover 25. While a slope 75 of the conical surface 72 of the cone member 70 will push the inclines 621 of the slide blocks 60, and the stop portion 511 of the sliding board 50 will stop the stop plate 74 of the cone member 70. At the moment, the conical surface 72 of the cone member 70 pushes the slopes 621 of the sliding blocks 60 backward such that the slide blocks 60 will move backward to press the springs 61 by virtue of the force of the inclines 621 (the slide blocks 60 stretch outward). The two retainer portions 63 are driven to stretch out too, while a transient clearance A appears between the sliding member 30 and the sliding board 50. The retainer portions 63 will not confine the door-opening spring 80 anymore until the same of the two slide blocks 62 detach from the engaging portion 293 of the adjustable bolt 29, and then the spring 80 starts to release its restoring force (ever greatest) to push the sliding board 50 toward the sliding member 30 (the sliding board 50 contacts the cushion ring 37 first and then abuts against the sliding member 30). At the moment, the sliding board 50 will not be veer away from the center when it move toward the sliding member 30 by virtue of the cooperation between the elliptical through hole 51 of the sliding board 50 and the conical surface 72 of the cone member 70. The door-opening spring 80 will push the sliding board 50 along with the sliding blocks 60 in the pedestals 54, such that when the sliding blocks 60 along with the slope 75 of the conical surface 72 of the cone member 70 move toward the sliding member 30, due to the cooperation between the slope 621 of the sliding blocks 60 and that 75 of the conical surface 72 of the cone member 70, the sliding blocks 60 will be pushed by the springs 61 and move toward the center, and then door-opening spring 80 pushes it with the ever greatest restoring force. While the door-closing spring 40 only has a rather minor elastic force (in an expanded state), thus the force of the door-opening spring 80 is greater than that of the door-closing spring 40. By such a manner, in case that the user pushes the door slightly, the door-opening spring 80 will provide a predetermined assistant force to open the door, such that the user almost needless to use his strength to open the door and the door may be opened (similar with the automatic door). Thereby, the door closer in accordance with the present invention has an assistant force of door opening.

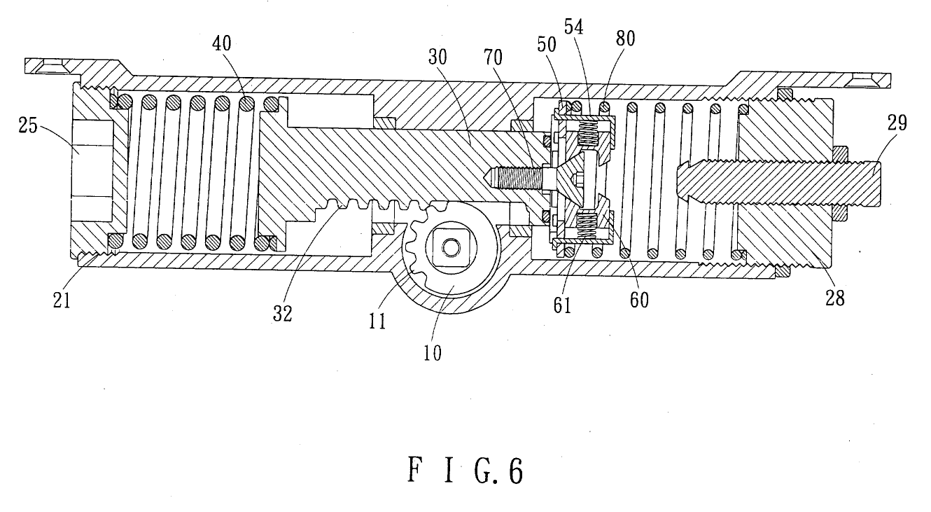

In case that the door is opened to the ultimate (with referring to FIG. 6), the force of the door-opening spring 80 is weakened (in an expanded state), while the elastic force of the door-closing spring 40 is strengthened (in a compressive state). Thereby the force of the door-closing spring 40 is great enough to counteract that of the door-closing spring 40 as well as the pushing force from the user, and to act as a reinforced buffering force such that will effect no strike nor noise but a buffering force with respect to the door-opening force.

And then, in case that the user releases the door panel (or close it by hand), the door-closing spring 40 will provide a rather great restoring force to close the door. The door-closing spring 40 expanded to release while the door-opening spring 80 compressed with storing energy, the closer the door is closed to the ultimate, the weaker the expansion force of the door-closing spring 40 becomes while the greater the compression force of the door-opening spring 80 becomes. Thereby the closer to the ultimate, the more great the buffering force becomes such that the door closer of the present invention has an assistant force in door-closing. When the door is closed to the ultimate, the door-closing spring 40 will push the sliding member 30 toward the adjusting cover 28 while the teeth 32 will drive the gear 11 of the door shaft 10 to revolve. At the moment, the door-opening spring 80 will provide a buffering force for preventing the strikes and noises. Until the sliding blocks 61 in the pedestals 54 of the sliding board 50 contacts the adjustable bolt 29, the bevel angles 631 in the front of the retainer portion 63 of the corresponding sliding blocks 60 will slide over the chamfer 292 of the adjustable bolt 29 and re-retained in the engaging portion 293. At this moment, despite the door-opening spring 80 has accumulated restoring force, which cannot be released due to confinement of the retainer portions 63.

It will be noted that make use of low-cost door-closing spring 40, sliding board 50, slide blocks 60 and door-opening 80 as substitution for expensive pneumatic (hydraulic) system to achieve a buffering and assistant effect, such that the production cost is saved.

On the other hand, the adjusting cover 28 of the housing 20 is engaged with the second inner threads 22, while the door-opening spring 80 is tensioned between the adjusting cover 28 of the housing 20 and the sliding board 50. By such a manner, the adjusting cover 28 and adjustable bolt 29 may be driven back and forth by rotating the anti-skid knurls 26 and 291 of the same respectively so as to adjust the elastic force of the door-opening spring 80 by adjusting the adjusting cover 28 as well as adjust the distance between the retainer portions 63 and the adjustable bolt 29 by adjusting the adjustable bolt 29. Thereby the buffering distance and force as well as locking position of the door closer of the present invention may be adjustable without difficulties.

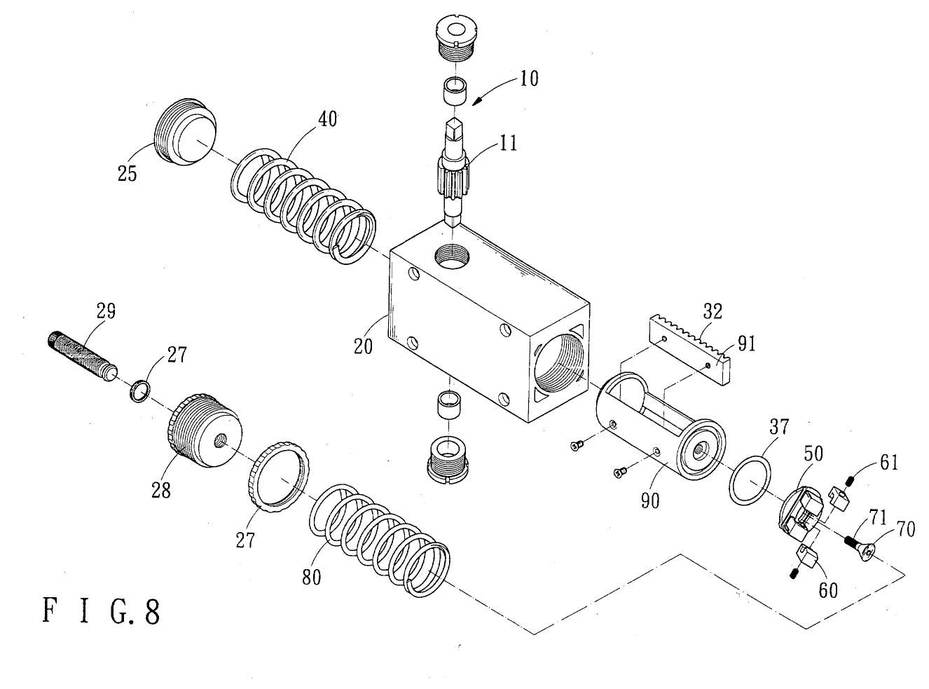

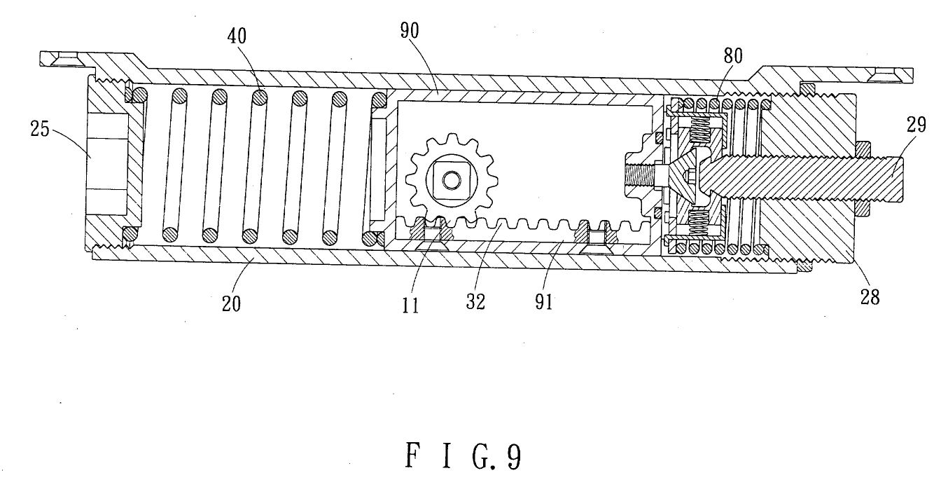

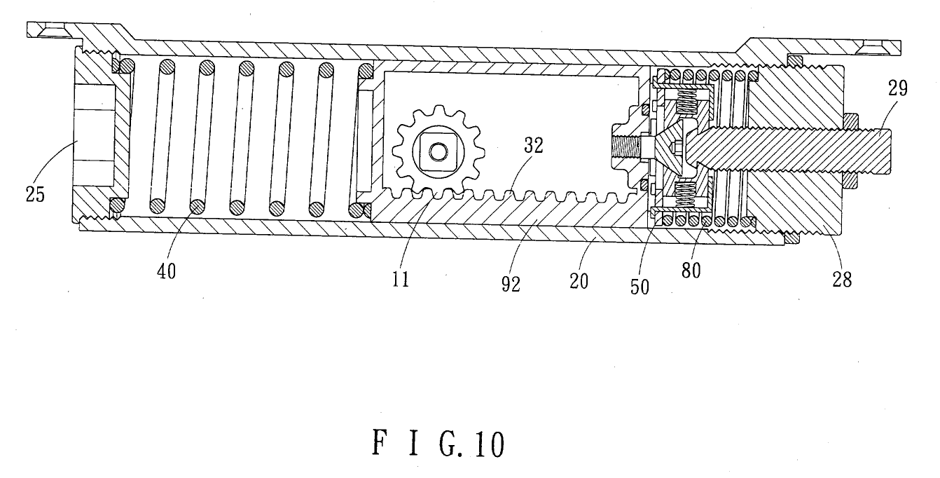

Referring to FIGS. 8-9, which shows a door closer in accordance with a second embodiment of the present invention, in which, the sliding member 30 of the present invention also can be consisted of a hollow member 90 and a plate 91. The plate 91 is provided with a plurality of teeth 32, while the gear 11 of the door shaft 10 is received in the internal hollow space of the hollow member 90 with the gear 11 engaging with the teeth 32 of the plate 91. With further referring to FIG. 10, which shows a door closer in accordance with a third embodiment of the present invention, in which, the sliding member 30 also can be a integrally formed hollow member 92 interiorly formed with a plurality of teeth 32.

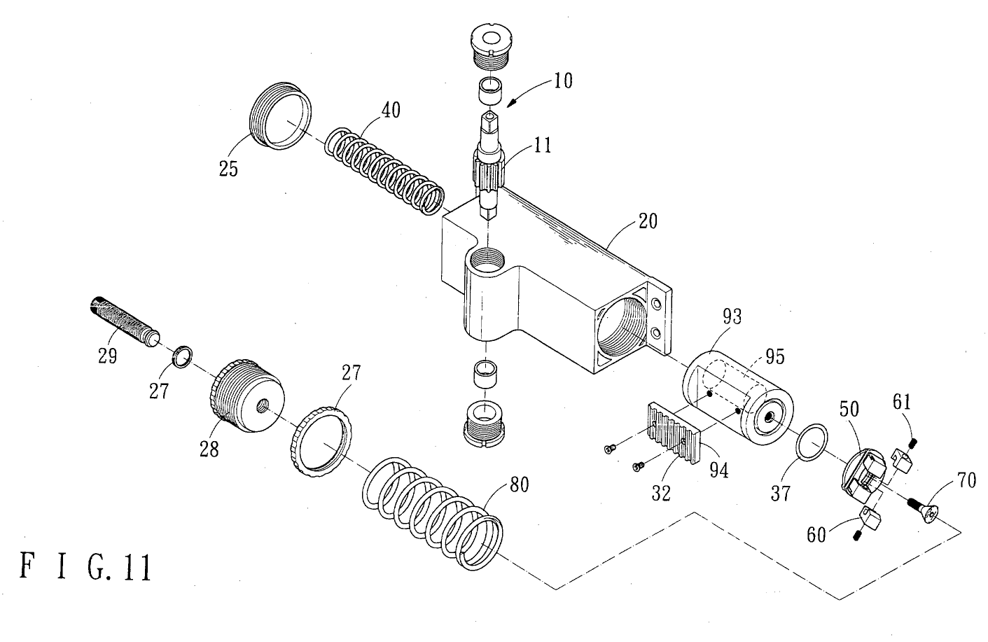

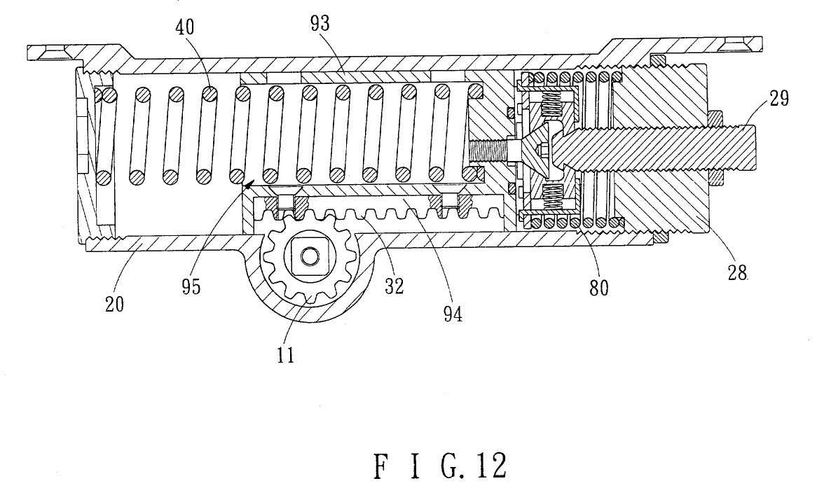

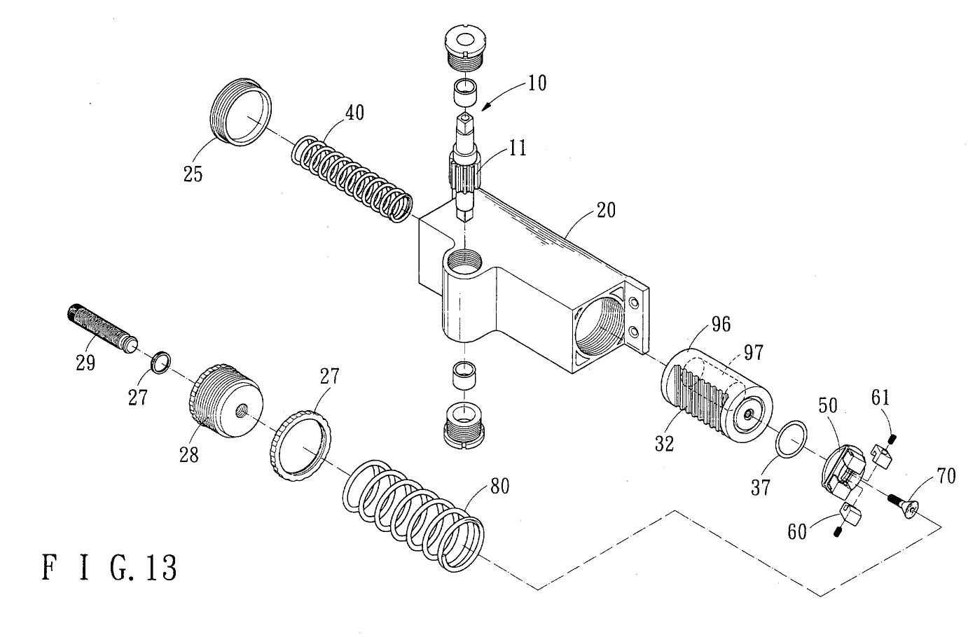

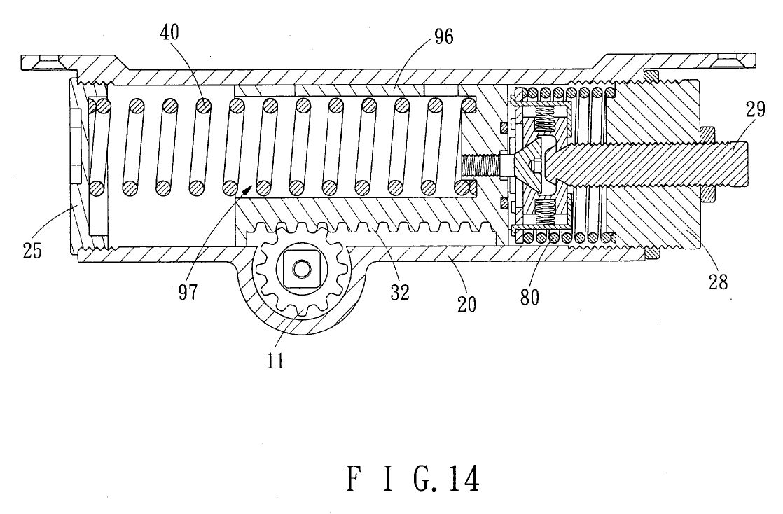

Referring now to FIGS. 11-12, which shows a door closer in accordance with a fourth embodiment of the present invention, in which, the sliding member 30 can be consisted of a tubular member 93 and a plate 94. The plate 94 is provided with a plurality of teeth 32, while the gear 11 of the door shaft 10 is engaged with the teeth 32 of the plate 94 and the bore 95 of the tubular member 93 serves for accommodation of the door-closing spring 40. By such a manner, the allowable length of the door-closing spring 40 may be relatively lengthened (so as to reinforce the door-closing force). The FIGS. 13-14 shows a door closer in accordance with a fifth embodiment of the present invention, in which, the sliding member 30 of the present invention can be a tubular member 96 provided with a plurality of teeth 32. The bore 97 of the tubular member 96 serves for accommodation of the door-closing spring 40; by such a manner, the allowable length of the door-closing spring 40 may be relatively lengthened (so as to reinforce the door-closing force).

While we have shown and described various embodiments in accordance with the present invention, it should be clear to those skilled in the art that further embodiments may be made without departing from the scope of the present invention.

What is claimed is:

1. A door closer comprising: a door shaft, a housing, a sliding member, a door-closing spring, a sliding board, a pair of sliding blocks, a cone member and a door-opening spring, wherein:
the housing has an engaging portion interiorly formed thereof, in the housing the sliding member is slidably disposed and engaged with the shaft simultaneously, the door-closing spring is tensioned between the housing and the flanged first end of the sliding member, the sliding board is slidably received in the housing, at a side of sliding board pedestals is disposed while at the center of the same a through hole is defined, the slide blocks each together with a spring is received in the corresponding pedestals of the sliding board respectively, each of the slide blocks is provided with a retainer portion corresponding to the engaging portions of the housing, the cone member is disposed at an end of the sliding member, at another end of the cone member is provided with a conical surface, whereby the conical surface is slidably received in the through hole of the sliding board, while the conical surface of the cone member is corresponding to the incline of the sliding blocks, the door-opening spring is tensioned between the housing and the sliding board.

2. The door closer as claimed in claim 1 comprising: a door shaft, a housing, a sliding member, a door-closing spring, a sliding board, a pair of sliding blocks, a cone member and a door-opening spring, wherein:
the door shaft revolves along with the opening and closing action of the door, and is provided with a gear;
the housing has an inner space interiorly defined thereof and at the inner edge of both ends of which is provided with a spring cover and an adjusting cover respectively, in the middle of the housing a hole is defined for receiving the door shaft therein, the adjusting cover has a threaded hole formed in the center, in which an adjustable bolt is engaged, at an end of the adjustable bolt where corresponding to the space of the housing is formed with a chamfer structure and contiguous to it an engaging portion defined thereof;
the sliding member is movably accommodated in the housing of the door closer, the sliding member has a flanged first end and a second end formed with a threaded hole, and the sliding member is provided with a plurality of teeth at the outer periphery for engaging with the gear of the door shaft;
the door-closing spring is employed to provide the force for closing door and tensioned between the spring cover of the housing and the flanged first end of the sliding member;
the sliding board movably is received in the inner space of the housing and simultaneously abuts against the sliding member, at a side corresponding to the adjusting cover the sliding board is provided with a pair of pedestals and located opposite to each other, the pedestals each has a recess also oppositely located, the two pedestals defines a space therebetween for insertion of the adjustable bolt of the housing, moreover, at the center of the sliding board an through hole is defined;
the slide blocks each together with a spring are received in the corresponding pedestals of the sliding board respectively, the slide blocks and the springs are confined but movable in the corresponding recesses, the extension of each slide blocks includes a retainer portion and a contacting portion, the contacting portion of each slide blocks has an incline formed at the end and the two inclines opposite located and each of which is outward inclined from the inner side corresponding to the sliding board, the retainer portions of each slide blocks corresponding to the engaging portions of the housing respectively;
the cone member movably is inserted in the center hole of the sliding board, which is provided with a rod at the end corresponding to the sliding member and a conical surface at the other end, the rod has threads defined at the end; the cone member is received in the sliding member, the conical surface is outward inclined from the inner side where corresponding to the sliding board and served to abut against the inclines of the each two slide blocks;
the door-opening spring is employed to provide force for opening the door and tensioned between the adjusting cover of the housing of the door closer and the sliding board.

3. The door closer as claimed in claim 2, wherein the housing is hollow member interiorly formed with space, and at both ends of which is provided with a first inner threads and a second inner threads respectively, the first inner threads is engaged with the spring cover, while the adjusting cover is engaged with the second inner threads.

4. The door closer as claimed in claim 2, wherein the sliding member consists of a hollow member and a plate, the plate is provided with a plurality of teeth, while the gear of the door shaft is received in the internal space of the hollow member with the gear engaged with the teeth of the plate.

5. The door closer as claimed in claim 2, wherein the sliding member is an integrally formed hollow member, at the inner side of the hollow member is defined with a plurality of teeth, while the gear of the door shaft is engaged with the teeth on the inner side of the hollow member.

6. The door closer as claimed in claim 2, wherein the sliding member consists of a tubular member and a plate, the plate is provided with a plurality of teeth, while the gear of the door shaft is engaged with the teeth of the plate, the bore of the tubular member for accommodation of the door-closing spring, whereby the allowable length of the door-closing spring may be relatively lengthened.

7. The door closer as claimed in claim 2, wherein the sliding member is a tubular member provided with a plurality of teeth, while the bore of the tubular member for accommodation of the door-closing spring, whereby the allowable length of the door-closing spring may be relatively lengthened.
